(19) United States
(12) Patent Application Publication
(10) Pub. No.: US 2006/0050184 A1
(43) Pub. Date: Mar. 9, 2006

(54) Hot/cold swappable consumer based tuner/demod/fec module

(75) Inventors: Daniel F. McMiller, Escondido, CA (US); William R. Doyle, San Diego, CA (US); Keith J. Kelley, Olivenhain, CA (US); Dinh C. Phan, San Diego, CA (US)

Correspondence Address: MAYER, FORTKORT & WILLIAMS, PC, 251 NORTH AVENUE WEST, 2ND FLOOR, WESTFIELD, NJ, 07090, US

(73) Assignee: General Instrument Corporation

(21) Appl. No.: 10/936,728

(22) Filed: Sep. 9, 2004

(51) Int. Cl. H04N 7/173; H04N 5/44; H04N 5/50

(52) U.S. Cl. 348/725; 725/100; 725/131; 348/731

(57) ABSTRACT

An apparatus (200) for receiving a digital terrestrial broadcast television signal in combination with another signal from another source includes a modular housing (400) enclosing a radio frequency tuner (211) for receiving the digital terrestrial broadcast television signals and a consumer premise component (320). The consumer premise component (320) includes an external housing (310) enclosing a tuner (210) to receive the other signal and a modular port (330) to accept the modular housing. The modular housing (340) is disposable in the modular port (330). A diplexer (212) can be externally mounted to the apparatus (200). The diplexer (212) includes an input (147) to accept a combined radio frequency signal that includes the other signal and the digital terrestrial broadcast television signal; a first output (142) to couple to the tuner (210); and a second output (143) to couple to the removable radio frequency tuner (211). The diplexer (212) filters the combined radio frequency signal to select the other signal and couple the other signal to the first output (142) and filters the combined radio frequency signal to select the digital terrestrial broadcast television signal and couple it to the second output (143). The other signals include a cable television signal, a satellite television signal, and/or a high definition satellite television signal. The modular housing includes power connections (431) that are relatively shorter in length than the ground connections (432) so that during removal of the removable radio frequency tuner (340) the power connections (431) decouple from the consumer premise component (320) before the ground connections (432) and during insertion the ground connections (432) make contact before the power connections.

### FIELD OF THE INVENTION

The present invention relates generally to systems and methods for receiving television signals, and more particularly, the present invention relates to a system and method for receiving television signals with a consumer electronic device located in a customer premises.

### BACKGROUND

The television (TV) has become ubiquitous in modern society. As a result, a variety of services are being provided via TV. Many of these services are provided using a consumer premise component, such as a set-top box that works in conjunction with the TV to provide the desired service. These consumer premise components enable standard television sets to receive video and/or audio signals transmitted over cable or satellite networks.

In conjunction with providing desired audiovisual services to consumers, consumer premise components also aid in maintaining a secure connection between the consumer and a transmitting entity by providing a descrambler or decoder unit, which unscrambles or decodes a signal carrying the desired programming. Unauthorized parties who do not have the consumer premise component will be unable to receive the audiovisual programming in an intelligible form.

However, the elements of the consumer premise components may readily become obsolete for a variety of reasons such as changing methods of encoding or the addition of new features and functions. For example, television will soon be broadcast terrestrially in digital format, and in some cases in High Definition digital format. Traditionally, the above-mentioned situations were remedied by providing authorized subscribers with a new consumer premise component containing an updated tuner/decoder unit designed to fully receive and translate the signals transmitted by the signal provider. However, this solution is both expensive and time consuming, especially if authorized subscribers are widely spread over a large geographic region.

The present invention is therefore directed to the problem of developing a method and apparatus for receiving signals from a signal provider in which a consumer may perform hardware updates to the apparatus.

### SUMMARY OF THE INVENTION

The present invention solves these and other problems by providing a method for and apparatus for receiving television signals that includes a housing to accept a cable tuner module that includes capability for receiving local terrestrial television signals in combination with an existing satellite or cable television signal receiver.

According to one aspect of the present invention, an apparatus for receiving a digital terrestrial broadcast television signal in combination with another signal from another source includes a consumer premise component with an external housing enclosing a tuner to receive the other signal and a modular port to accept a modular housing. The modular housing is disposable in the modular port, and includes a removable radio frequency tuner to receive the digital terrestrial broadcast television signal. The embodiment may include an externally mountable diplexer with an input to accept a combined radio frequency signal that includes the other signal and the digital terrestrial broadcast television signal. One diplexer output is coupled to the tuner and another diplexer output is coupled to the removable radio frequency tuner. The diplexer filters the combined radio frequency signal to select the other signal and couple the other signal to the first output and filters the combined radio frequency signal to select the digital terrestrial broadcast television signal and couples it to the second output. The embodiment may also include a cantilever snap formed in the modular housing. The cantilever snap is configured to securely couple the modular housing to the external housing of the consumer premise component.

According to another aspect of the present invention, a modular housing for use in the present invention includes one or more grounding pins on a connector interface that are longer than the power pins on the same connector interface. During installation of the modular unit into the modular port, this ensures that the grounding pins make contact with the ground connection of the consumer premise component before the power pins of the modular housing make contact with the power connections, thereby enabling the modular housing to be hot swappable, e.g., the modular housing can be replaced while power is applied to the consumer premise component without causing harm to the modular component, the consumer premise component or to the user. Moreover, the length of the pins ensure that during removal of the modular unit the grounding pins remain in contact with the ground connections of the consumer premise component while the power pins are removed from contacting the power connections of the consumer premise component.

### BRIEF DESCRIPTION OF THE DRAWINGS

The accompanying drawings illustrate various embodiments of the present system and method and are a part of the specification. Together with the following description, the drawings demonstrate and explain the principles of the present system and method. The illustrated embodiments are merely examples of the present system and method and in no way limit the scope thereof.

FIG. 1 is a block diagram of an exemplary embodiment of a satellite television network with a tree-and-branch architecture according to one aspect of the present invention.

FIG. 2 is a block diagram of an exemplary embodiment of an integrated receiver decoder according to another aspect of the present invention.

FIG. 3 is a perspective view of an exemplary embodiment of an upgradeable consumer premise component according to yet another aspect of the present invention.

FIG. 4 is a perspective view of an exemplary embodiment of an upgrade tuner module according to still another aspect of the present invention.

FIG. 5 is an exploded view of an exemplary embodiment of components of an upgrade tuner module according to yet another aspect of the present invention.

FIG. 6 is an internal view of an exemplary embodiment of a tuner module casing top according to still another aspect of the present invention.

FIG. 7 is an external view of an exemplary embodiment of a tuner module casing top according to yet another aspect of the present invention.

FIG. 8 is a top view of an exemplary embodiment of a tuner module casing top having a cantilevered latch according to still another aspect of the present invention.

FIG. 9 is a cross-sectional side view of an exemplary embodiment of a cantilevered latch that forms a part of the tuner module casing according to yet another aspect of the present invention.

FIG. 10 is magnified cross-sectional side view of an exemplary embodiment of a cantilevered latch that forms a part of the tuner module casing according to still another aspect of the present invention.

FIG. 11 is a flow chart of an exemplary embodiment of a method for installing a tuner module according to yet another aspect of the present invention.

FIG. 12 is a flow chart of an exemplary embodiment of a method for removing a tuner module according to still another aspect of the present invention.

FIG. 13 is a perspective view of an exemplary embodiment of an installed upgrade tuner module according to yet another aspect of the present invention.

FIGS. 14-15 depict an exemplary embodiment of a method for installing a diplexer module to the back of a consumer premise component according to still another aspect of the present invention.

FIG. 16 depicts a block diagram of an exemplary embodiment of a tuner for receiving terrestrial digital broadcast television according to yet another aspect of the present invention.

FIG. 17 is a perspective view of an exemplary embodiment of an upgrade tuner module according to yet another aspect of the present invention.

Throughout the drawings, identical reference numbers designate similar, but not necessarily identical, elements.

### DETAILED DESCRIPTION

The present specification describes a number of exemplary methods and systems for forming a user installable/removable tuner module. More specifically, the present system and method provide an upgrade tuner module housing that includes a cantilevered latch. The cantilevered latch allows an installation of the upgrade tuner module by a consumer without the aid of tools. The individual components and methods of using the user installable/removable tuner module are described in detail below.

As used in the present specification and in the appended claims, the term “consumer premise component” or “CPC” is meant to be understood broadly as including any set-top box, satellite receiver, lightweight modular display system (LMDS), multimedia display system (MMDS), or any IRD (integrated receiver/decoder). Additionally, “audiovisual programming” or “audiovisual signal” includes video and audio signals, whether transmitted alone or in combination as well as data, games (or other programs), graphics, control, telephony, text or other information independent of format.

A “set-top box” or “STB” is meant to be understood broadly as any electrical component that is configured to be located at a consumer location, receive a signal from a signal transmission source such as a satellite head-end unit a cable head-end unit, and/or terrestrial signals from local broadcasts, and process data associated with the received signal. One example of a set-top box is an “integrated receiver decoder” or “IRD.”

In the following description, for purposes of explanation, numerous specific details are set forth in order to provide a thorough understanding of the present system and method for forming a removable upgrade tuner module. It will be apparent, however, to one skilled in the art that the present system and method may be practiced without these specific details. Reference in the specification to “one embodiment,” “an embodiment,” or “an exemplary embodiment” means that a particular feature, structure, or characteristic described in connection with the embodiment is included in at least one embodiment. The phrases “in one embodiment” and “in an exemplary embodiment” appear in various places in the specification and are not necessarily all referring to the same embodiment.

Exemplary Overall Structure

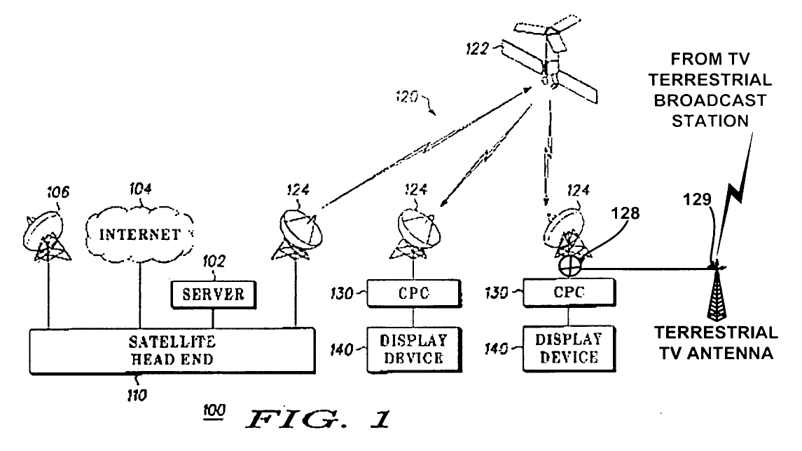

Referring now to the drawings, FIG. 1 illustrates an exemplary embodiment of a satellite television network (100) with a tree-and-branch architecture according to one aspect of the present invention. As shown in FIG. 1, the satellite television network (100) includes a satellite headend unit (110). Also shown in FIG. 1, a number of data sources (102, 104, 106) may be communicatively coupled to the satellite headend unit (110) including, but in no way limited to, a plurality of servers (102), the Internet (104), radio signals, or television signals received via a satellite connection (106). The satellite headend (110) is also communicatively coupled to one or more consumer premise components (130) through a satellite broadcast network (120). The consumer premise component (130) may then be coupled to a display device (140). In addition, a terrestrial broadcast television receiving antenna (129) is coupled to the consumer premise component (130) via a summer (128). The terrestrial broadcast television receiving antenna receives digital or analog broadcast television signals from a terrestrial television broadcast station or stations (not shown). Summer (128) combines the signals from the satellite antenna (124) and the terrestrial television antenna (129) into a single transmission line, which is then coupled to the consumer premise component (130), which is typically located inside the user's home. This enables the consumer premise component (130) to receive both satellite high definition television signals and terrestrial high definition signals, for example, or other combinations of satellite (digital and high definition) and terrestrial (analog, digital and high definition) television signals.

As shown in FIG. 1, the satellite headend (110) is coupled to a number of data sources (102, 104, 106). The satellite headend (110) illustrated in the exemplary embodiment shown in FIG. 1 may be any centralized facility or a system at a satellite TV office that originates and communicates satellite TV services and/or satellite modem services to subscribers. The satellite TV services and/or satellite modem services may be received by the satellite headend (110) from any number of sources including those listed above. These satellite TV services can include digital satellite TV as well as High Definition satellite TV. Once received in the satellite headend (110), the TV services and/or satellite modem services are encoded to eliminate redundant or irrelevant data, and information is extrapolated to reduce the overall size of the files providing the services. The TV services and/or satellite modem services are also encrypted prior to transmission to prevent unauthorized access to the signals.

The satellite broadcast network (120) illustrated in FIG. 1 is the medium over which the RF signals produced by the satellite headend unit (110) or by a CPC (130) are transmitted. The satellite broadcast network (120) may be any medium configured to transmit RF signals including, but in no way limited to, a satellite (122) to dish (124) network, a coaxial cable network, a fiber optic cable network, a local terrestrial or wireless network, or a hybrid cable network. In general, consumer premise component (130) receives at least two types of signals—terrestrial broadcast and satellite/cable broadcast signals. Other combinations are also possible though, including but not limited to cable modem signals, analog TV, digital TV, data, HDTV, cable TV, digital CATV, analog CATV, etc.

Once transmitted through the satellite broadcast network (120), two downstream signals are received by a designated consumer premise component (CPC) (130)—one from the satellite dish antenna (124) and another from a terrestrial receiving antenna on the user's roof or other location. A summer (128) combines these two signals into a single RF transmission signal, which is transmitted down a cable to the CPC (130), which is split into its two components by a diplexer (212), which consists of a high pass filter to select the L-band signals from the satellite (or cable plant) and a low pass signal to select the terrestrial broadcast signals.

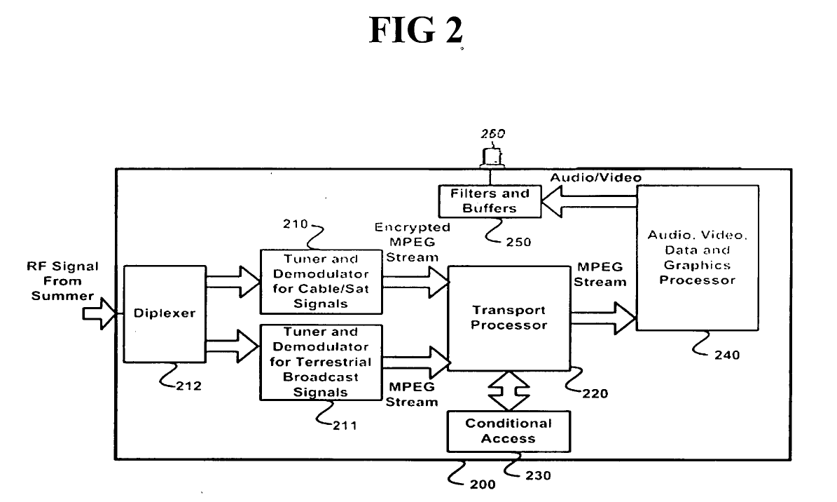

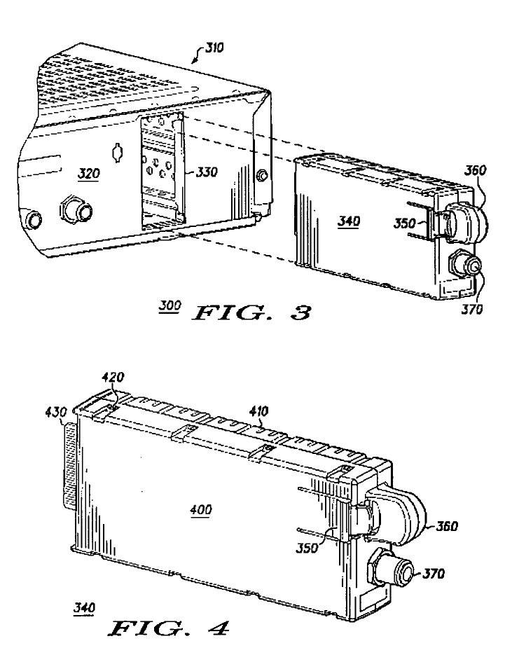

FIG. 2 illustrates the internal components of a CPC (130) according to one exemplary embodiment. As shown in FIG. 2, a CPC in the form of an integrated receiver decoder (200) includes a tuner and demodulator for the cable/sat signals (210) communicatively coupled to a transport processor (220). The transport processor (220) is in turn communicatively coupled to a media access control unit (conditional access device) (230) and an audio, video, data, and graphics processor (240). The audio, video, data, and graphics processor (240) is then coupled to a number of filters and buffers (250) which lead to a signal out connection (260) that may then be communicatively coupled to an external display device (140; FIG. 1). The CPC (130) also includes a tuner/demodulator for terrestrial broadcast TV signals (211) that fits in the modular slot shown in FIG. 3. This tuner/demodulator (211) receives terrestrial broadcast television signals, including analog, digital or high-definition signals. Tuner (210) receives the other signals, such as satellite television, cable television, satellite high definition, digital cable signals, or some other like video/audio or Internet signals. The CPC (130) also includes an external mounted diplexer (212), which includes two filters (e.g., one high pass filter for L-band signals and one low pass filter for signals below L-band) to individually select the terrestrial broadcast television signal for input to the tuner/demodulator (211) and another filter to select the other signals (e.g., high definition satellite television signal) for input to tuner (210). Typically, the signals from the terrestrial broadcast source are not encrypted so the need not be processed by the conditional access unit (220).

As noted above, the internal components of the CPC (130; FIG. 1), such as the tuner and demodulator (210), may become outdated or useless due to any number of conditions. Consequently, upgradeable consumer premise components configured to receive upgrade modules have been developed. As illustrated in FIG. 3, the upgradeable consumer premise component (300) includes a CPC chassis (310) having a back plate (320) and a module port (330) disposed within the back plate. Additionally, a removable upgrade module (340) is included in FIG. 3. This removable upgrade module (340) can be the terrestrial broadcast tuner module or it could be the satellite or cable receiver module, depending upon the original configuration of the CPC (130; FIG. 1).

Traditionally, the removable upgrade modules (340) associated with upgradeable consumer premise components included a casing made out of a metal or another conductive material and a number of external fasteners configured to securely couple the removable upgrade module (340) to the components of the upgradeable CPC (300). Additionally, traditional removable upgrade modules often require the removal of the CPC chassis (310) to access the internal components of the CPC. However, the use of the external fasteners, as well as the need to access the internal components of the upgradeable CPC resulted in relegating the insertion of a removable upgrade module (340) to a service person having access to a number of specialized tools.

In contrast to traditional upgrade modules (340), the removable upgrade module (340) illustrated in FIG. 3 includes a cantilever snap (350) formed in the housing and the handle (360) of the removable upgrade module (340). The cantilever snap (350) formed in the housing and the handle (360) of the removable upgrade module (340) is configured to effectively secure the removable upgrade module (340) in the module port (330) without the use of extra hardware or complicated consumer installation, as will be developed in further detail below. Moreover, as illustrated in FIG. 3, the removable upgrade module (340) includes an F-connector (370) extruding from the housing of the removable upgrade module. The cantilever snap (350), the handle (360), and other individual elements of the removable upgrade module (340) will be described in further detail below with reference to FIGS. 4 through 10.

As illustrated in FIG. 4, the removable upgrade module (340) includes a front housing member (400) and a back housing member (410) coupled together by a plurality of housing couplers (420). Additionally, as illustrated in the exemplary embodiment of FIG. 4, the handle (360) extrusion of the removable upgrade module (340) is formed in both the back housing (410) and the front housing (400). Moreover, the cantilever snap (350) is formed in the front housing (400) and forms a portion of the handle (360), as illustrated in FIG. 4. An F-connector (370) is also illustrated extruding from a first end of the housing of the removable upgrade module (340), while a processor interface (430) is extruding from a second end of the housing, opposite the first end.

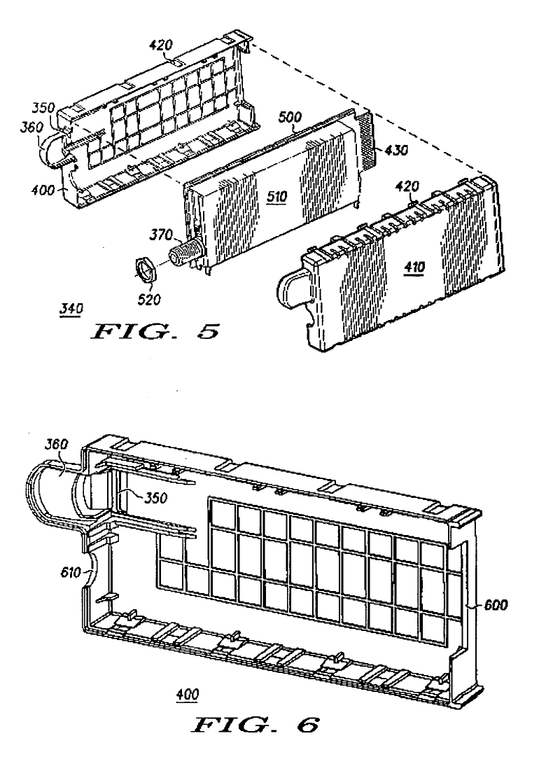

FIG. 5 is an exploded view further illustrating the internal components of the removable upgrade module (340), according to one exemplary embodiment. As illustrated in FIG. 5, an upgrade tuner module (510) is disposed within the module housings (400, 410). As illustrated in FIG. 5, the upgrade tuner module (510) includes an F-connector (370) and a processor interface (430) communicatively coupled to a tuner module printed circuit board (500).

According to the present system and method, the F-connector (370) is configured to receive an input data signal from a terrestrial broadcast network. The F-connector (370) portion of the upgrade tuner module (510) is a common coaxial connector used for video applications. While the present exemplary embodiment is illustrated in the context of a tuner module printed Circuit board (500) communicatively coupled to an F-connector (370), any connector used to receive data signals from a network may be used including, but in no way limited to, an s-video connector, a fiber-optic cable connector, or an RCA connector.

A tuner module printed circuit board (PCB) (500) is communicatively coupled to the F-connector (370) of the tuner module (510). According to the exemplary embodiment illustrated in FIG. 5, the tuner module PCB (500) includes circuitry configured to function as a vestigial side band (VSB)/phase shift keying (PSK) tuner module. Alternatively, the tuner module PCB (500) may be configured to decode any number of coded signals including, but in no way limited to, coded orthogonal frequency division multiplexing (COFDM) signals.

Leading from the tuner module PCB (500), a processor interface (430) is communicatively coupled to the tuner module PCB (500). According to one exemplary embodiment, the processor interface (430) is an extension of the tuner module PCB (500) having a number of leads that correspond to a module reception coupler (not shown) that is coupled to the transport processor (220; FIG. 2) disposed within the module port (330). According to this exemplary embodiment, when the processor interface (420) is inserted into the module port (330; FIG. 3) and communicatively coupled to the transport processor (220; FIG. 2) of the consumer premise component, the upgrade tuner module (400) may receive a coded audiovisual signal and demodulate that signal into a signal acceptable by the upgradeable consumer premise component (300; FIG. 3). According to one exemplary embodiment, the circuitry of the upgrade tuner module (400) also receives power through the processor interface (420).

When assembled, the tuner module (510) is disposed within the housing portion of the removable upgrade module with the F-connector (370) and the processor interface (430) each extruding from opposite ends of the housing, respectively. Once disposed within the housing, the front housing (400) and the back housing (410) may be coupled together by the housing couplers (420), thereby forming a protective housing around the tuner module (510). The housing couplers (420) used to couple the front housing (400) to the back housing (410) may be any coupling means including, but in no way limited to, male interference extrusions inserted into a female orifice. Additionally, a fastener (520) may be coupled to the F-connector (370), after the removable upgrade module (340) has been assembled, in order to further secure the position of the tuner module (510) within the front (400) and back housings (410). The fastener (520) may include, but is in no way limited to, a nut threaded onto the external threads of the F-connector (370).

FIG. 6 is a bottom view further illustrating the structure of the front housing (400), according to one exemplary embodiment. As illustrated in FIG. 6, the front housing includes an F-connector recess (610) and an interface recess (600). The F-connector recess (610) and the interface recess (600) are withdrawn portions of the front housing (400) wall configured to form a housing orifice on the assembled housing. Additionally, FIG. 6 illustrates the cantilever snap (350) formed within the handle (360) and body portions of the front housing (400).

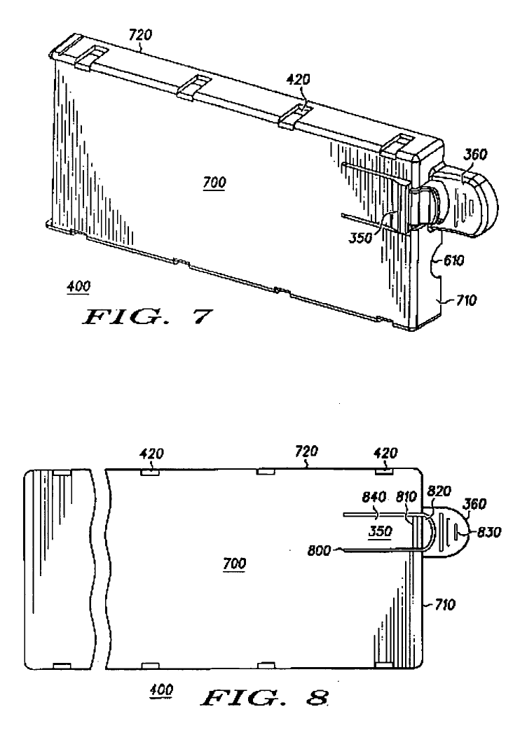

FIG. 7 is a top perspective view illustrating the components of the front housing (400), according to one exemplary embodiment. As illustrated in FIG. 7, the front housing (400) includes a front surface (700), a plurality of side walls (720) and top walls (710). As illustrated in FIG. 7, the front housing (400) may include a plurality of housing couplers (420), disposed in the side wall (720) of the front housing. The housing couplers (420) disposed in the side wall (720) of the front housing (400), may be either male or female portions of a coupling pair, with the corresponding mate being formed on the back housing (410; FIG. 4).

FIG. 8 is a top view illustrating the components of the cantilever snap (350) and the handle (360) according to one exemplary embodiment. As illustrated in FIG. 8, the present front housing (400) includes a handle (360) extrusion formed on the top wall (710) of the front housing (400). Additionally, a cantilever snap (350) is anchored to the front surface (700) of the front housing (400) and extends into the handle portion (360) of the front housing.

The handle (360) portion of the front housing (400) is configured to aid in the grasping and subsequent insertion and removal of the removable upgrade module (340). Consequently, a number of features of the handle (360) aid in the grasping thereof. According to one exemplary embodiment illustrated in FIG. 8, the handle (360) includes a number of ribbed friction extrusions (830). The ribbed friction extrusions (830) are configured to increase the friction experienced when a human finger grips or otherwise contacts the surface of the handle (360). Additionally, a handle lip (820) portion of the cantilever snap (350) is formed to extend into and follow the contours of the handle (360), thereby avoiding an obstruction to the grasping of the handle (360).

The cantilever snap (350) portion of the exemplary front housing (400) illustrated in FIG. 8 is anchored to the front surface (700) of the front housing (400) and extends into the handle portion (360). The cantilever snap (350) includes a cantilever body (840) ending with the handle lip (820). Additionally, an interference extrusion (810) is formed on the surface of the cantilever body (840). A cantilever gap (800) surrounds the cantilever snap (350), separating the cantilever snap from a majority of the front housing (400).

The cantilever snap (350) of the present system and method may be any extrusion, which is fixed at one end and free at all others. Generally, cantilevers are unable to translate or rotate at the fixed support, while the free end may do both. Consequently, both force and moment reactions may be present at the handle lip (820) portion of the present cantilever snap (350). The amount of deflection experienced by the present cantilever snap for a fixed load may be varied by varying the length of the cantilever snap (350), varying the location of the load with respect to the end of the cantilever snap, and by varying the material properties of the cantilever snap. A number of variations of the above-mentioned characteristics may be performed by the present system and method. According to one exemplary embodiment, the present cantilever snap (350) is made of plastic, having a favorable modulus of elasticity.

FIG. 9 is a cross sectional view further illustrating the interaction between the cantilever snap (350) and the handle (360). As illustrated in FIG. 9, a lip recess (900) is formed in the handle (360) portion of the front housing (400). The lip recess (900) is formed adjacent to the handle lip (820) portion of the cantilever snap (350) in order to permit an unobstructed deflection of the cantilever snap. As illustrated in FIG. 9, when un-deflected, the cantilever body (840) is parallel with the front surface (700) of the front housing (400). Consequently, there is no obstruction in the sliding of the removable upgrade module (340; FIG. 3) into a module port (330; FIG. 3) until the interference extrusion (810) makes contact with the CPC back plate (320; FIG. 3). However, in order to accommodate the passing of the interference extrusion (810) past the CPC back plate (320; FIG. 3), the cantilever snap (350) is deflected. The size and configuration of the lip recess (900) allows an unobstructed deflection of the cantilever snap (350).

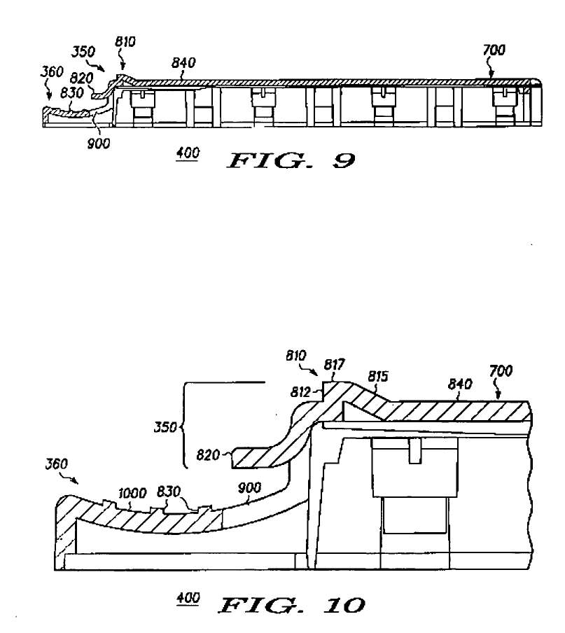

FIG. 10 further illustrates the individual elements of the cantilever snap that enable the present removable upgrade module (340; FIG. 3) to be engaged and remove from a CPC without the use of specialized tools. As illustrated in FIG. 10, the cantilever snap (350) includes an interference extrusion (810) configured to securely couple the removable upgrade module (340; FIG. 3) to the module port (330; FIG. 3) of an upgradeable CPC (300; FIG. 3). According to the exemplary embodiment illustrated in FIG. 10, the profile of the interference extrusion (810) includes, moving towards the handle (360) portion of the front housing (400), an interference incline (815) coupled to the cantilever body (840). A smooth transition exists between the front surface (700) of the front housing (400; FIG. 4), the cantilever body (840), and the interference incline (815). This smooth transition allows for an unhindered insertion of the removable upgrade module (340; FIG. 3). Continuing on in the same direction, the interference extrusion (810) levels off to a plateau surface (817) approximately parallel with the front surface (700) of the front housing (400; FIG. 4). After the plateau surface (817), the interference extrusion (810) angles approximately 90 degrees towards the inner portion of the front housing (400; FIG. 4). The sharp angle of the above-mentioned profile forms an interference face (812), which will securely couple the removable upgrade module (340; FIG. 3) to the module port (330; FIG. 3) of an upgradeable CPC (300; FIG. 3), as will be further described in detail below.

Continuing from the interference face (812), the cantilever snap (350) substantially follows the profile of the front housing (400; FIG. 4) until the handle lip (820) is formed. As illustrated in FIG. 10, the handle lip (820) substantially follows the curvature of the handle (360). However, as illustrated in FIG. 10, when in an un-deflected state, the handle lip (820) is somewhat removed from the lip recess (900). According to one exemplary embodiment, the distance the handle lip (820) is removed from the lip recess (900) corresponds to the height of the interference extrusion (810).

FIG. 10 also illustrates the exemplary profile of the handle portion (360) of the front housing (400; FIG. 4). According to this exemplary embodiment, the handle includes a concave body (1000) having a number of friction extrusions (830) disposed thereon. Both the concave body (1000) and the friction extrusions (830) are configured to aid in the removal and insertion of the removable upgrade module (340; FIG. 3) without specialized tools or training.

According to one exemplary embodiment of the present system and method, the present housing of the removable upgrade module (340; FIG. 3) is constructed of a non-conductive material such as plastic. According to this exemplary embodiment, manufacture of the module housing using plastic allows for less expensive and more temporally efficient manufacture through efficient plastic forming methods including, but in no way limited to, injection molding. Alternatively, the present system and method may be formed out of materials including, but in no way limited to, metals, plastics, composites, or appropriate mixtures thereof.

Exemplary Implementation and Operation

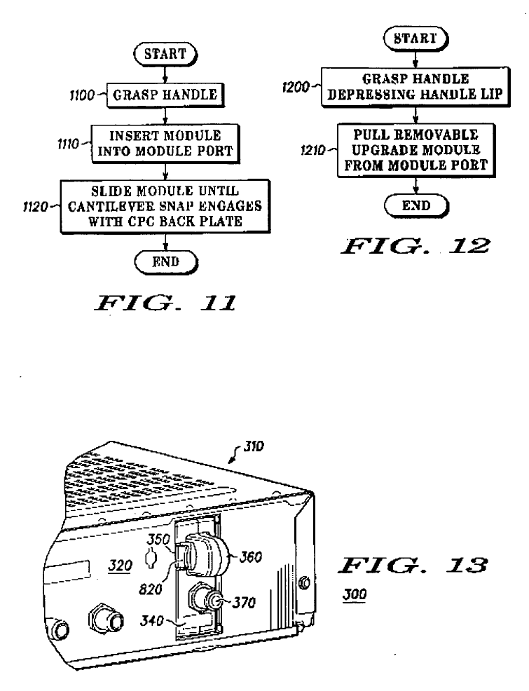

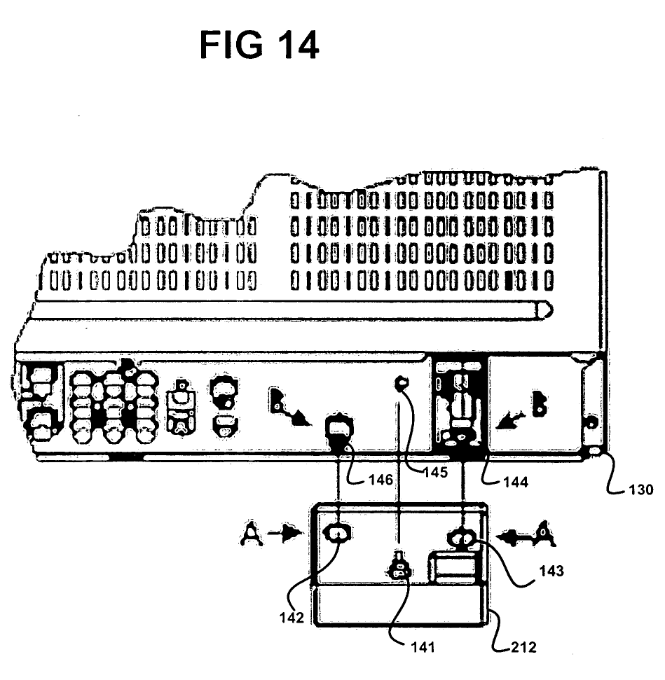

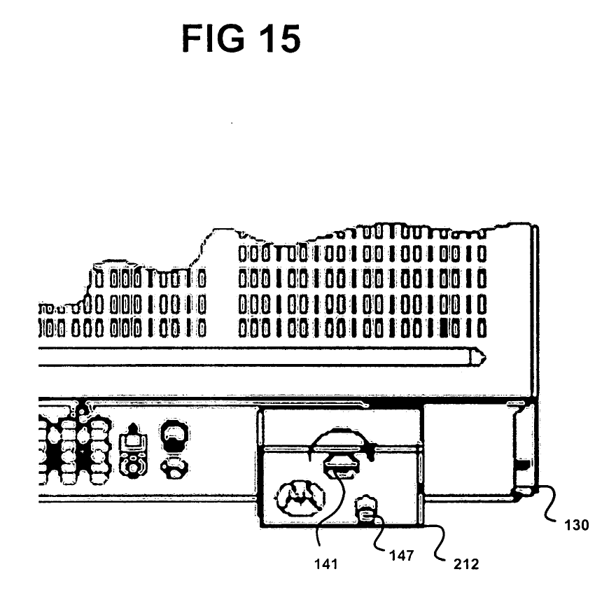

FIG. 11 illustrates a method for installing the removable upgrade module (340; FIG. 3), according to one exemplary embodiment. As illustrated in FIG. 11, the present method includes grasping the handle portion of the removable upgrade module (step 1100) and inserting the removable upgrade module into the module port of an upgradeable CPC (step 110). Once the module has been inserted into the module port (step 1110), the module may be slid inside the module port until the cantilever snap engages with the CPC back plate (step 1120). Further explanation of the above-mentioned steps will now be given below.

As noted above, the present method for installing a removable upgrade decoder into an upgradeable CPC includes a user grasping the handle portion (360; FIG. 10) of the removable upgrade module (step 1100). According to the exemplary embodiment illustrated in FIG. 10, the grasping of the handle portion (360) of the removable upgrade module (340; FIG. 3) is facilitated by the shape and characteristics of the handle (360). The inclusion of the friction extrusions (830) and the concave body (1000) allow a user to securely grip the handle portion (360; FIG. 10) of the removable upgrade module (340; FIG. 3). Additionally, the shape of the cantilever snap (350) prevents any obstruction of the handle portion (360; FIG. 10).

Once the handle portion (360) of the removable upgrade module (340; FIG. 3) is grasped by a user, it may be inserted into the module port (330; FIG. 3) of an upgradeable CPC (300; FIG. 3). According to one exemplary embodiment illustrated in FIG. 3, the module port (330) is configured to accept the removable module (340) without permitting lateral movement of the removable module. That is, a number of guides or other structural elements may be included in the module port (330) to assure the processor interface (430; FIG. 4) of the removable module (340) is translated directly to an interface receiving port (not shown) that is communicatively coupled to the transport processor (220; FIG. 2). According to this exemplary embodiment, the removable module (340) is inserted by leading the processor interface (430; FIG. 4) into the module port (330).

Once inserted, the removable upgrade module (340) is slid, being guided by the guides or other structural elements, until the processor interface (430; FIG. 4) of the removable module (340) is translated to an interface receiving port (step 1120; FIG. 11). According to this exemplary embodiment, when the removable upgrade module (340) is sufficiently inserted into the module port (330) to communicatively couple the processor interface (430; FIG. 4), the cantilever snap (350; FIG. 3) engages the CPC back plate (320), thereby securely coupling the removable upgrade module (340; FIG. 3) to the upgradeable CPC (300).

FIG. 13 illustrates a removable upgrade module (340) securely coupled to an upgradeable CPC (300). As illustrated in FIG. 13, an engaged removable upgrade module (340) is slid into the module port (330; FIG. 3) sufficiently to engage the cantilever snap (350) with the CPC back plate (320). According to one exemplary embodiment, as the removable upgrade module (340) is translated into the module port (330; FIG. 3), the edge of the CPC back plate (320) contacts the front surface (700) of the removable upgrade module housing. Sufficient space exists between the CPC back plate (320) and the removable upgrade module (340) to permit substantially unrestrained insertion of the module. However, once the cantilever snap (350) contacts the CPC back plate (320), a deflection of the cantilever snap may occur. As the interference incline (815; FIG. 8) contacts the CPC back plate (320), further translation of the module forces the cantilever snap towards the center of the housing, until the plateau (817; FIG. 8) portion of the interference extrusion (810; FIG. 8) is substantially flush with the front surface (700; FIG. 8). As the interference extrusion (810; FIG. 8) is further translated past the CPC back plate (320), the cantilever snap (350) is permitted to return to its original position. As a result, the interference face (812; FIG. 8) forms an interference fit with the inner surface of the CPC back plate (320). Consequently, the present removable upgrade module remains securely coupled to the upgradeable CPC (300).

FIG. 12 illustrates a method for removing the present removable upgrade module (340), according to one exemplary embodiment. As illustrated in FIG. 12, the removable upgrade module may be removed by grasping the handle while simultaneously depressing the cantilever snap (step 1200). As the handle lip (820; FIG. 8) portion of the cantilever snap is depressed, the cantilever snap (350; FIG. 8) is deflected at least until the plateau (817; FIG. 8) of the interference extrusion (810; FIG. 8) is in line with the front surface (700) of the module housing, thereby removing any interference between the module and the CPC backplate (320).

Once the cantilever snap is grasped and sufficiently deflected, the user may then pull the removable upgrade module from the module port (step 1210). Sufficient deflection of the handle lip (820; FIG. 8), and consequently the interference extrusion, will eliminate the interference with the CPC back plate (320; FIG. 13). A pull by the user while grasping the handle portion (360; FIG. 3) of the removable upgrade module (340; FIG. 13) will remove the module from the upgradeable CPC (300; FIG. 13).

In conclusion, the present system and method for forming a user installable/removable tuner module simplifies the installation of an upgrade tuner module while reducing module production costs. More specifically, a consumer operable plastic cantilever snap and handle are molded into a plastic housing that surrounds a printed wiring assembly (PWA). The cantilever snap retains and disengages the module while the handle aids in the grasping of the module for insertion and removal. The use of the above plastic cantilever snap and handle eliminate the use of extra hardware to retain the module. This elimination of extra hardware reduces storage costs, inventory costs, and manufacturing labor when compared to traditional methods. Additionally, the present system and method is easy to use, thereby reducing installation time while eliminating the need for a complicated consumer installation, which could include a need for extra tools, a consumer loosing hardware, or a consumer damaging the module during installation.

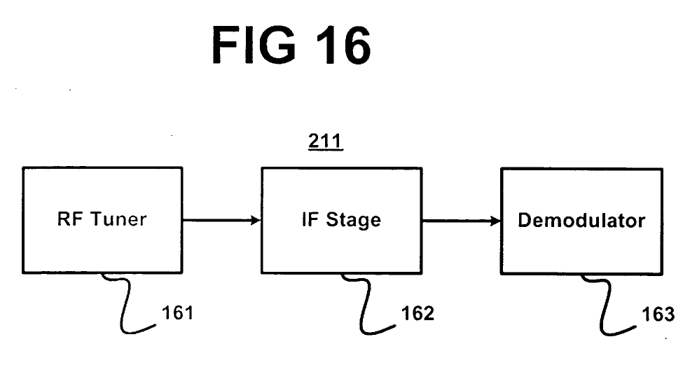

Turning to FIG. 16, according to another aspect of the present invention, an exemplary embodiment 211 of a consumer hot-swappable tuner includes a digital module to be used in ATSC digital (8-VSB, 16-VSB & 64-QAM) TV reception. The exemplary embodiment includes: an RF tuner 161, which receives RF ATSC signal & down-converts it to an IF frequency of 44 MHz; an IF Stage 162, which consists of two SAW filters and gain controllable IF amplifiers and outputs a 1.0Vp-p IF signal with a good IF selectivity; and a demodulator 163, which demodulates the IF signal to a baseband serial or parallel MPEG transport streams. A block diagram of this exemplary embodiment is shown in FIG. 16.

The exemplary embodiment enables the set-top box or receiver to receive digital off-air and cable signals. The resulting receiver then outputs both MPEG-2 Serial and Parallel Transport Streams, demodulates and filters 8/16-VSB and 64/256-QAM signals.

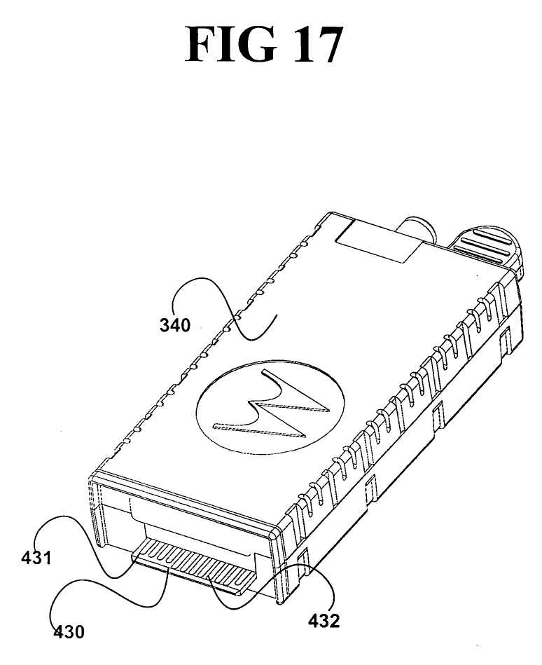

Turning to FIG. 17, shown therein is an exemplary embodiment of a hot swappable modular unit 340. This unit can include many different types of electronic devices. However, the unit 340 is hot swappable due to inter alia the design of the interface connection 430 of the module unit 340 to the consumer premise component (not shown). According to one embodiment of the interface connection 430, the ground pins 432 are extended relative to the power/signal pins 431 allowing for ground to make contact first, then power, during a hot insertion. This along with the proper power sequencing (performed by the power supply in the consumer premise component) ensures that the module will power up correctly during a hot insertion. When the module 340 is removed (hot) from the slot 330 with power applied, the power pins 431 disconnect first, then the ground pins 432, ensuring that module 340 will power down correctly. Additionally, the exposed pins of the module 340 are Electronic Surge Discharge (ESD) protected (e.g., with diodes) in order to prevent damage to the ICs inside the module when being handled.

As an additional measure, the power lines are protected in the consumer premise component with recoverable fuses, so that a short circuit condition on the consumer premise component side of this interface does not hang or damage the consumer premise component (e.g. when a child sticks a spoon into the exposed IRD connector and shorts power to ground).

The preceding description has been presented only to illustrate and describe the present system and method. It is not intended to be exhaustive or to limit the present system and method to any precise form disclosed. Many modifications and variations are possible in light of the above teachings. For example, a cantilever snap may be formed on either or both the front and the back housing of the present removable upgrade module. Additionally, any number of materials may be used to form the present module.

The foregoing embodiments were chosen and described in order to illustrate principles of the system and method as well as some practical applications. The preceding description enables others skilled in the art to utilize the system and method in various embodiments and with various modifications as are suited to the particular use contemplated. It is intended that the scope of the system and method be defined by the following claims.

What is claimed is:

1. An apparatus (200) for receiving a digital terrestrial broadcast television signal in combination with another signal from another source comprising:
a consumer premise component (320) including an external housing (310) enclosing:
a tuner (210) to receive the other signal; and
a modular port (330) to accept a modular housing; and
a modular housing (340) being disposable in the modular port (330), said modular housing (340) including a removable radio frequency tuner (211) to receive the digital terrestrial broadcast television signal.

2. The apparatus (200) according to claim 1, further comprising an externally mountable diplexer (212) including:
an input (147) to accept a combined radio frequency signal that includes the other signal and the digital terrestrial broadcast television signal;
a first output (142) to couple to the tuner (210); and
a second output (143) to couple to the removable radio frequency tuner (211), said diplexer (212) filtering the combined radio frequency signal to select the other signal and couple said other signal to the first output (142) and filtering the combined radio frequency signal to select the digital terrestrial broadcast television signal and couple it to the second output (143).

3. The apparatus (200) according to claim 1, wherein said modular housing (340) further comprises:
an interface connection (430) including one or more ground connections (432) and one or more power connections (431), said one or more ground connections (432) being longer in length relative to the one or more power connections (431).

4. The apparatus (200) according to claim 1, wherein said modular housing (340) further comprises:
a printed circuit board interface connection (430) including one or more printed circuit board ground connections (432) and one or more printed circuit board power connections (431), said one or more printed circuit board ground connections (432) being longer in length relative to the one or more printed circuit board power connections (431), whereby during removal of the modular housing (340) from the modular port (330) said one or more printed circuit board power connections (431) decouple from the consumer premise component (320) before the one or more printed circuit board ground connections (432) decouple from the consumer premise component (320) and during insertion of the modular housing (340) into the modular port (330) said one or more printed circuit board ground connections (432) couple to the consumer premise component (320) before the one or more printed circuit board power connections (431) couple to the consumer premise component (320).

5. The apparatus (200) according to claim 1, wherein said modular housing further comprises:
a cantilever snap (350) formed in said modular housing (400), said cantilever snap (350) being configured to securely couple said modular housing (400) to the external housing (310) of the consumer premise component (320).

6. The apparatus (200) according to claim 1, wherein said another signal includes a high definition satellite television signal, a cable television signal or a satellite signal.

7. The apparatus (200) according to claim 1, wherein said modular housing (400) further comprises:
an F-connector orifice (610) disposed in a first end of said modular housing (400); and
a processor interface orifice (600) disposed in a second end of said modular housing (400).

8. The apparatus (200) according to claim 1, further comprising:
a printed wiring assembly (430) disposed in said modular housing (400), said printed wiring assembly (430) including one or more ground connections (432) and one or more power connections (431), said one or more ground connections (432) being longer in length relative to the one or more power connections (431), wherein said printed wiring assembly (430) is configured to receive and decode the digital terrestrial broadcast television signal.

9. An apparatus (200) for receiving digital terrestrial broadcast television signals in combination with other signals from another source comprising:
a consumer premise component (320) including a tuner (210) to receive the other signals and a port (330) to accept a removable unit; and
a removable radio frequency tuner (211) to be disposed in the port (330) of the consumer premise component (320) and to receive the digital terrestrial broadcast television signals, said removable radio frequency tuner (211) including:
a printed wiring interface (430) to couple to the consumer premise component, said printed wiring interface including one or more ground connections (432) and one or more power connections (431), said one or more ground connections (432) being longer in length relative to the one or more power connections (431).

10. The apparatus (200) according to claim 9, further comprising an externally mountable diplexer (212) including:
an input (147) to accept a combined radio frequency signal that includes the other signal and the digital terrestrial broadcast television signal;
a first output (142) to couple to the tuner; and
a second output (143) to couple to the removable radio frequency tuner (211), said diplexer (212) filtering the combined radio frequency signal to select the other signal and couple said other signal to the first output (142) and filtering the combined radio frequency signal to select the digital terrestrial broadcast television signal and couple it to the second output (143).

11. The apparatus (200) according to claim 9, further comprising:
a cantilever snap (350) formed in said modular housing (400), said cantilever snap (350) being configured to securely couple said modular housing (400) to the external housing (310) of the consumer premise component (320).

12. The apparatus (200) according to claim 9, wherein said modular housing (400) further comprises:
an F-connector orifice (610) disposed in a first end of said modular housing (400); and
a processor interface orifice (600) disposed in a second end of said modular housing (400).

13. The apparatus (200) according to claim 9, wherein said one or more power connections (431) are relatively shorter in length than one or more ground connections (432) whereby during removal of the removable radio frequency tuner (340) from the port (330) said one or more power connections (431) decouple from the consumer premise component (320) before the one or more ground connections (432) decouple from the consumer premise component (320) and during insertion of the removable radio frequency tuner (340) into the port (330) said one or more ground connections (432) couple to the consumer premise component (320) before the one or more power connections (431) couple to the consumer premise component (320).

14. A consumer premise component (320) comprising:
a body (310);
a tuner (210) to receive a first signal;
a modular port (330) formed in said body (310); and
a removable radio frequency tuner (340) to receive digital terrestrial broadcast television signals, said removable radio frequency tuner (340) configured to be securely coupled to said modular port (330).

15. The consumer premise component (320) according to claim 14, further comprising:
a modular housing (400) enclosing the removable radio frequency tuner (340), said modular housing (400) including:
an interface (430) to couple to the body (310), said interface including one or more ground connections (432) and one or more power connections (431), said one or more ground connections (432) being longer in length relative to the one or more power connections (431).

16. The consumer premise component (320) according to claim 14, further comprising an externally mountable diplexer (212) including:
an input (147) to accept a combined radio frequency signal that includes the first signal and the digital terrestrial broadcast television signal;
a first output (142) to couple to the tuner (210); and
a second output (143) to couple to the removable radio frequency tuner (211), said diplexer (212) filtering the combined radio frequency signal to select the first signal and couple said first signal to the first output (142) and filtering the combined radio frequency signal to select the digital terrestrial broadcast television signal and couple it to the second output (143).

17. The consumer premise component (320) according to claim 14, further comprising:
one or more power lines to couple to power; and
one or more fuses coupled to the one or more power lines in the consumer premise component (320).

18. The consumer premise component (320) according to claim 15, wherein said modular housing (400) further comprises:
electronic surge protection coupled to the interface.

19. The consumer premise component (320) according to claim 15, wherein said one or more power connections (431) are relatively shorter in length than one or more ground connections (432) whereby during removal of the removable radio frequency tuner (340) from the port (330) said one or more power connections (431) decouple from the consumer premise component (320) before the one or more ground connections (432) decouple from the consumer premise component (320) and during insertion of the removable radio frequency tuner (340) into the port (330) said one or more ground connections (432) couple to the consumer premise component (320) before the one or more power connections (431) couple to the consumer premise component (320).

20. A modular component (340) for insertion into a consumer premise component (320) comprising:
a radio frequency tuner (340) to receive digital terrestrial broadcast television signals, said removable radio frequency tuner (340) configured to be securely coupled to a modular port (330) in the consumer premise component (320).
a modular housing (400) enclosing the radio frequency tuner (340);
a cantilever snap (350) formed in said housing (400), said cantilever snap (350) being configured to securely couple said modular housing (400) to a body (310) of the consumer premise component (320); and
a handle (360) formed on an edge of said modular housing (400);
a printed wiring assembly (430) disposed in said modular housing (400), said printed wiring assembly (430) including an interface (430) to couple to the consumer premise component (320), said interface including one or more ground connections (432) and one or more power connections (431), said one or more ground connections (432) being longer in length relative to the one or more power connections (431), wherein said printed wiring assembly (430) is configured to receive and decode the digital terrestrial broadcast television signal;
an F-connector orifice (610) disposed in a first end of said modular housing (400); and
a processor interface orifice (600) disposed in a second end of said modular housing (400).
